(19) United States
(12) Patent Application Publication
(10) Pub. No.: US 2018/0187428 A1
(43) Pub. Date: Jul. 5, 2018

(54) DEVICE FOR LOCKING DOWN SCAFFOLD BOARDS

(71) Applicant: Justin MAHER, Woodrising (AU)

(72) Inventor: Justin MAHER, Woodrising (AU)

(21) Appl. No.: 15/741,152

(22) PCT Filed: Jun. 30, 2016
(86) PCT No.: PCT/AU2016/050563

§ 371 Date: Dec. 29, 2017

(30) Foreign Application Priority Data
Jul. 1, 2015 (AU) 2015101464
May 9, 2016 (AU) 2016202971

(51) Int. Cl. E04G 7/28; F16B 9/02

(52) U.S. Cl. CPC E04G 7/28; F16B 9/023

(57) ABSTRACT

A device for locking down a board of a platform supported on transoms connected between standards of a scaffold, including a riser adapted to be positioned lengthwise of one of the standards, a keeper positioned transversely of the riser to hold the board in place and a coupling to engage a fitting on the standard to lock the device in position.

### FIELD

This invention relates to a device for locking down scaffold boards.

### BACKGROUND

The key elements of a scaffold are standards, ledgers and transoms which are generally assembled as interconnected scaffold bays. The standards, also called uprights, are the vertical components along an inside and outside of each of the scaffold bays. Ledgers are horizontal components which connect between the standards. Transoms connect the standards at right angles to the ledgers while providing a supporting structure for scaffold boards which run lengthwise of the bay between the inner and outer standards.

Hop-ups provide supporting structure for additional scaffold boards outside of the line of the standards. The hop-ups have transom elements that are cantilevered from the standards and the boards extend between the transom elements to provide a working platform.

The boards are traditionally secured to the supporting structure using tie-wire or strapping, if secured at all.

### Object

The present invention seeks to provide an alternative means of securing scaffold boards.

### SUMMARY

In accordance with the invention, there is provided a device for locking down a board of a platform supported on transoms connected between standards of a scaffold, including a riser adapted to be positioned lengthwise of one of the standards, a keeper positioned transversely of the riser to hold the board in place and a coupling to engage a fitting on the standard to lock the device in position.

In one embodiment, the riser includes a base with an aperture that provides access to a void between upright parts of the riser to accommodate a wedge lock used to connect the platform to the scaffold.

In one embodiment, the upright parts extend up to the coupling and laterally shield the coupling from damage, knocks and accidental release.

In one example, the coupling is adapted to engage an inner standard and the device further includes a second riser and coupling connected to an opposite end of the keeper, to engage with an associated fitting of an outer standard.

In one example, the keeper is adapted to hold multiple boards and is in the form of an elongate bar that extends across a top surface of the boards in order to hold the boards in a horizontal orientation.

In one example, the device further includes a step section adjacent one of the risers to accommodate a kick board mounted along a lateral edge of the platform.

In one example, the device further includes a stop for an end of the kickboard to abut when the kickboard is received in the step section.

In one example, the stop is in the form of a vertical tab positioned intermediate side edges of the step section.

In one example, the step section provides an L-shaped connection between the adjacent riser and the keeper.

In one example, the device is adapted to secure boards of a hop-up platform, and further includes a downturned lip remote from the riser to secure an outside edge of the platform.

In one example, the keeper is in the form or an elongate bar that extends across a top surface of the boards, and wherein the lip projects downwardly from an end of the keeper.

In one example, the or each coupling includes a spigot for quick connect engagement with a fitting of the associated standard.

In one example, the or each coupling includes a wedge lock for connection with a V-press fitting of the associated standard.

In another example, the or each coupling includes a spigot or blade for connection with a cup lock system of the associated standard.

In another example, the or each coupling includes a spigot or wedge for connection with a ring or rosette mounted on the associated standard.

In another aspect, there is provided scaffold with standards and a device, as described above, the standards having one or more fittings to engage with the or each coupling of the device.

### BRIEF DESCRIPTION OF THE DRAWINGS

The invention is described, by way on non-limiting example only, with reference to the accompanying drawings, in which:

FIG. 1 is a front view of a device for locking down scaffold boards;

FIG. 2 is a bottom view of the device;

FIG. 3 is a side view of the device;

FIG. 4 is a plan view of the device;

FIG. 5 illustrates the device in use;

FIG. 6 is a front view of a device for locking down a kickboard;

FIG. 7 is a side view of the device of FIG. 6;

FIG. 8 illustrates the device of FIG. 6 in use;

FIG. 9 is a front view of a device of locking down boards of a hop-up;

FIG. 10 illustrates the device of FIG. 7 in use;

FIGS. 11a to 11c illustrate an alternative system for connecting a device for locking down scaffold boards to the associated standards;

FIGS. 12a to 12c illustrate the system used for connecting a device for locking down a kickboard to the associated standards;

FIGS. 13a to 13c illustrate the system used for connecting a device for locking down boards of a hop-up to the associated standards;

FIGS. 14a to 14c illustrate another system for connecting a device for locking down scaffold boards to the associated standards;

FIGS. 15a to 15c illustrate the system when used for connecting a device for locking down a kickboard to the associated standards; and

FIGS. 16a to 16c illustrate the system used for connecting a device for locking down boards of a hop-up to the associated standards.

### DETAILED DESCRIPTION

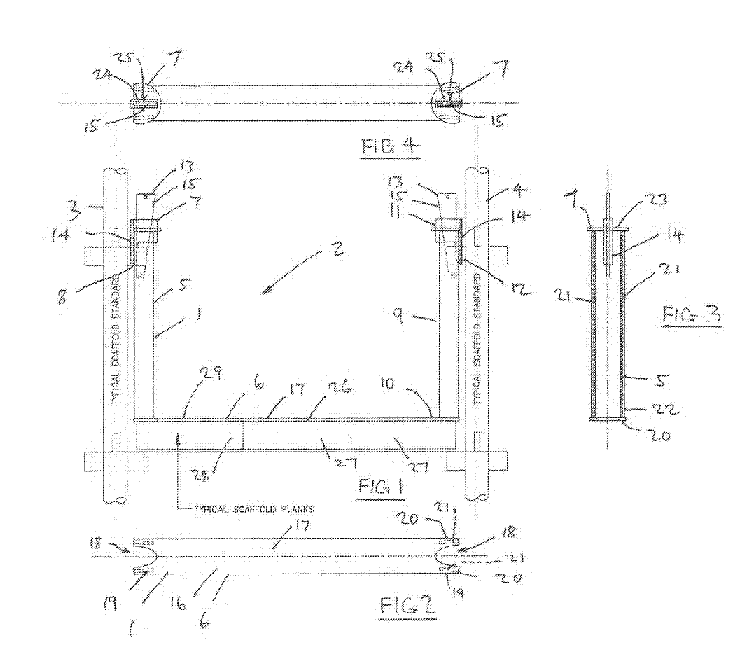

FIG. 1 shows a device 1 forming part of a scaffold 2, between an inner and an outer standard 3, 4. The device 1 includes a riser 5 that extends lengthwise of the inner standard 3, a keeper 6 and a coupling 7 to connect the riser 5 to a V-press fitting 8 on the standard 3.

The device 1 also includes a second riser 9 at a remote end 10 of the keeper 6. The second riser 9 extends lengthwise of the outer standard 4, up to a second coupling 11 that engages with V-press fitting 12 of the outer standard 4.

The V-press fitting 8, 12 is a common form of V-shaped fitting welded at regular intervals along a length of the standards 3, 4. Other conventional fittings such as ring or cup style fittings may instead be used, as required.

Each coupling 7, 11 is formed as a wedge lock 13 for connecting to the associated V-press fitting 8, 12. The wedge lock 13 includes a spigot or connecting finger 14, also known as a banana, and a wedge 15 for quick connect engagement with the associated fitting 8, 12. To secure the coupling 7, 11 to the fitting 8, 12, the couplings 7, 11 are positioned so that the finger 14 is lowered into the fitting 8, 12. The wedge 15 is then hammered into position to frictionally lock the coupling 7, 11 to the associated V-shaped fitting 8, 12.

FIG. 2 shows an underside 16 of the device 1. The keeper 6 is formed of an elongate bar 17 with an aperture/notch 18 in either end 19 that defines lateral connecting feet 20 for the risers 5, 9. Each riser 5, 9 is formed of two separate upright parts 21 that are welded to a respective foot 20 at a slightly divergent angle toward each end 19 of the keeper 6.

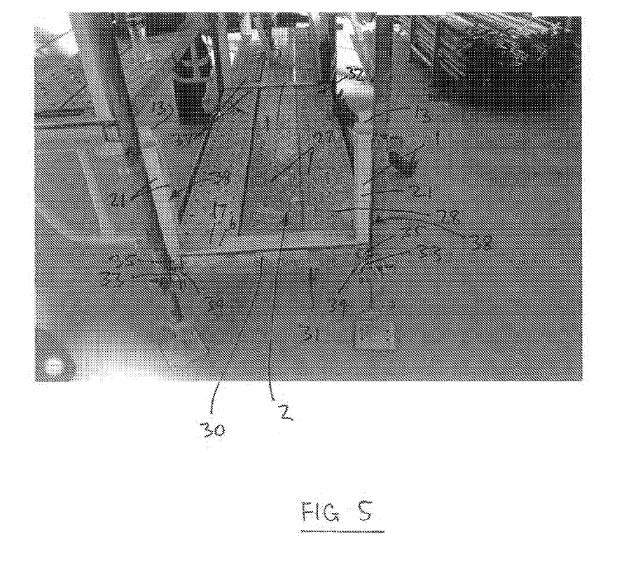

FIG. 3 shows the parts 21 of the riser 5 extending from a base 22, where the riser is connected to the feet 20, up to a cross piece 23 which forms part of the coupling 7. The connecting finger 14 extends down from the cross piece 23.

FIG. 4 shows the coupling 7 also includes a guide 24 that is located centrally of the cross piece 23 to provide a slot 25 for receipt of the wedge 15, which is then able to align centrally of the associated V-press fitting 8, as shown in FIG. 1.

With reference again to FIG. 1, the keeper 6 is shown extending laterally between the two risers 5, 9. The bar 17 rests across a top surface 26 of scaffold boards 27 and serves to lock the boards 27 down, in a horizontal orientation, when the couplings 7, 11 are engaged with the respective fittings 8, 12 of the standards 3, 4.

Three boards are shown in FIG. 1, however the device 1 may hold down a different number of boards, as required. Also, throughout the specification, reference to a “board” is to be taken to mean reference to either a board or a plank made of any material.

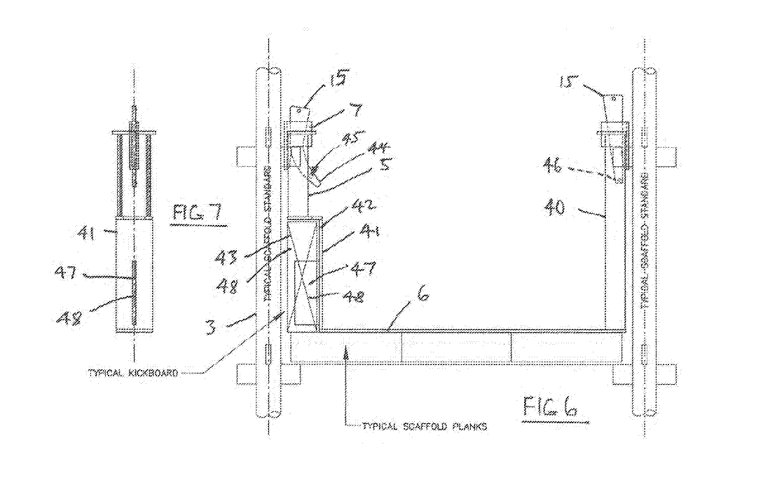

The boards 27 form part of a platform 28 supported between the standards 3, 4 in order to provide a substantially horizontal deck 29, as defined by the top surfaces 26 of the boards 27. The platform 28 rests on a transom 30 at either end 31, 32 of the scaffold bay 2, as shown in FIG. 5.

The transom 30 in FIG. 5 is attached to fittings 33 by brackets 34 and corresponding wedge locks 35. The apertures/notches 18, as described with reference to FIG. 2, overlay and accommodate the wedge locks 35 by providing access to associated voids 38 defined between the upright parts 21 to avoid any obstruction from the wedge locks 35 when the device 1 is lowered and locked in position. The upright parts 21 prevent the wedge locks from being a trip hazard and/or from being accidently knocked into a release condition.

The upright parts 21 also extend up to the wedge locks 13 and serve to shield and protect the wedge locks 13 of the device 1 from lateral damage, knocks and accidental release.

Multiple devices 1 can be used along the length of the scaffold 36 to lock down the boards 27 at either end 37 of the platform 28. Also, since the ends 37 of each platform 28 are adjacent and the flat bar 17 of the keeper 6 has a width dimension sufficient to overlap the boards 27 of two adjacent platforms 28, one device 1 can be used to lock down the boards 27 on two adjacent platforms 28.

Turning now to FIG. 6, another device 40 is shown with many similar components to the device 1 described with reference to FIGS. 1 to 5 and like parts will be denoted with like reference numbers.

The device 40 includes a step section 41 adjacent the riser 5. The step section 41 forms an inverted L-shaped connection 42 between the riser 5 and the keeper 6. The section 41 accommodates a kickboard 43 arranged in a generally vertical orientation between the keeper 6 and the standard 3.

The wedge 15 of the coupling 7 has a scooped tail 44 with a hole 45 that can be used to lock the wedge 15 against unintentional removal of the wedge 15 from the coupling 7. A similar hole 46 is provided in the wedge 15 of the other coupling 11.

The device 40 also includes a stop 47 for an end 48 of the kickboard 43 to abut when the kickboard 43 is received in the step section 41. The stop 47 is in the form of an elongate tab 48.

Referring to FIG. 7, the tab 48 extends vertically at a central location relative to the section 41 so that the tab 48 forms a stop 47 whichever side of the tab the kickboard is located or, alternatively, provides a stop between abutting ends of two kickboards 43 received from either side of the device 40.

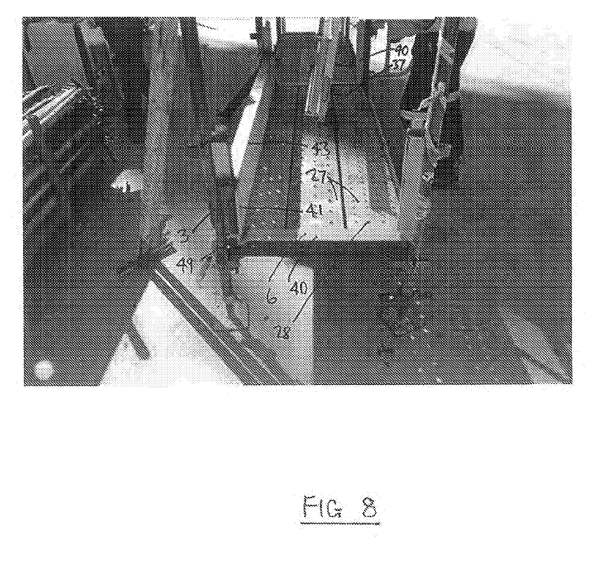

FIG. 8 illustrates the device 40 of FIG. 7 in use. The keeper 6 holds the boards 27 in place and the step section 41 holds the kickboard 43 against the standard 3.

The step section 41 creates a void for accommodating a wedge 49 used to lock the platform 28 to the standard 3.

Another device 41 is located at a remote end 37 of the platform 28 to hold the kickboard 43 against the adjacent standard 3.

Referring now to FIG. 9, a device 50 is shown which is suitable for securing boards 27 of a hop-up 51. Components similar to those described with reference to FIGS. 1 to 8 will be denoted with like reference numbers.

The hop-up 51 includes a cantilevered frame 52 that is locked into a V-press fitting of the standard 3 using a wedge lock 53. The frame 52 supports a platform 28 formed of the boards 27. The frame 52 is in turn supported by a bracket 54 that extends between the platform 28 and the standard 3.

The device 50 is used to lock down the boards 27 of the hop-up 51. For the purpose, the keeper 6 extends over the top surface 26 of the boards 27 to hold the boards 27 down in a horizontal orientation. In that position, the coupling 7 engages with the fitting 55 of the standard 3 to lock the device 50 in place.

The device 50 further includes a downwardly projecting lip 56 remote from the riser 5. The lip 56 is integral with the end 10 of the keeper 6 and secures an outside edge 57 of the platform 28. The lip 56 also includes a return 58 that extends under the frame 52 in order to provide additional security to the hop-up.

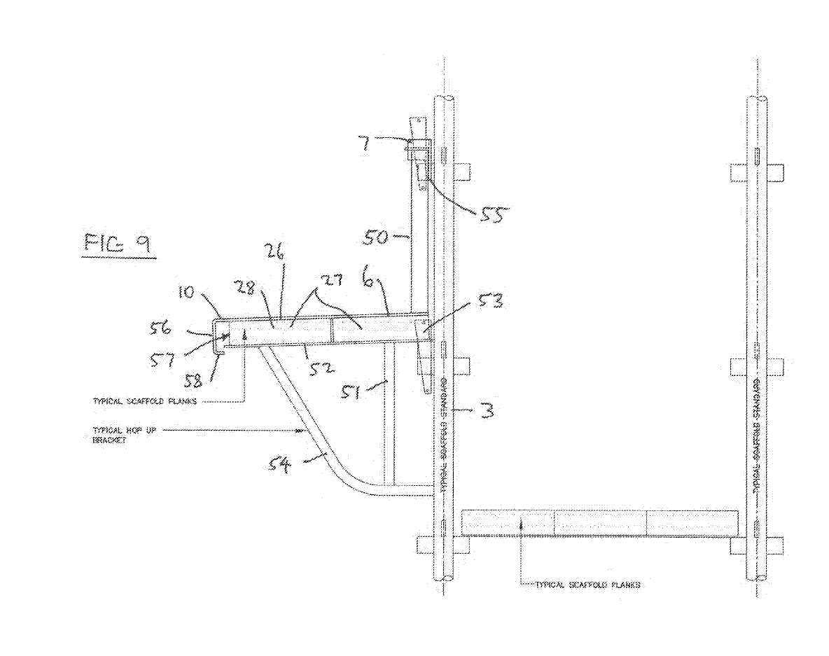

FIG. 10 shows the device 50 in use, where the boards 27 of the hop-up 51 are locked in place by the keeper 6.

As may be appreciated from the above, the invention allows scaffold boards 27 to be quickly and securely locked in place using existing scaffold fittings and no additional tie-downs or straps are needed. The device 1, 40, 50 has been described as having a coupling 7 that includes a wedge lock 13, however, the wedge lock 13 is only one form of coupling specifically suited for a V-press fitting 8. If an alternative form of fitting is used on the scaffold, such as a ring or cup type fitting, the form of the coupling can be modified, as required.

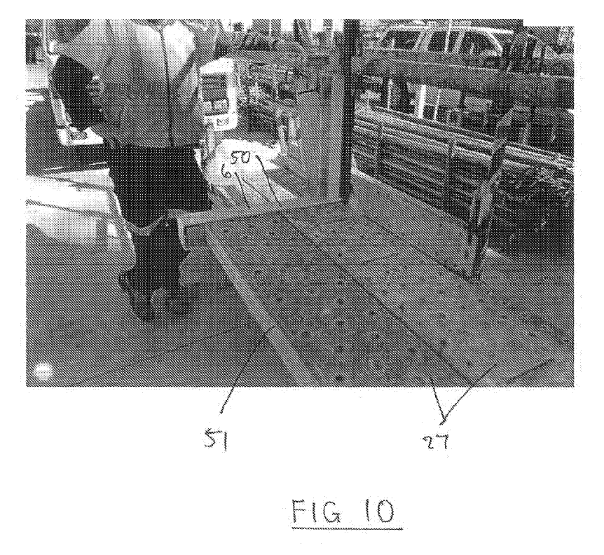

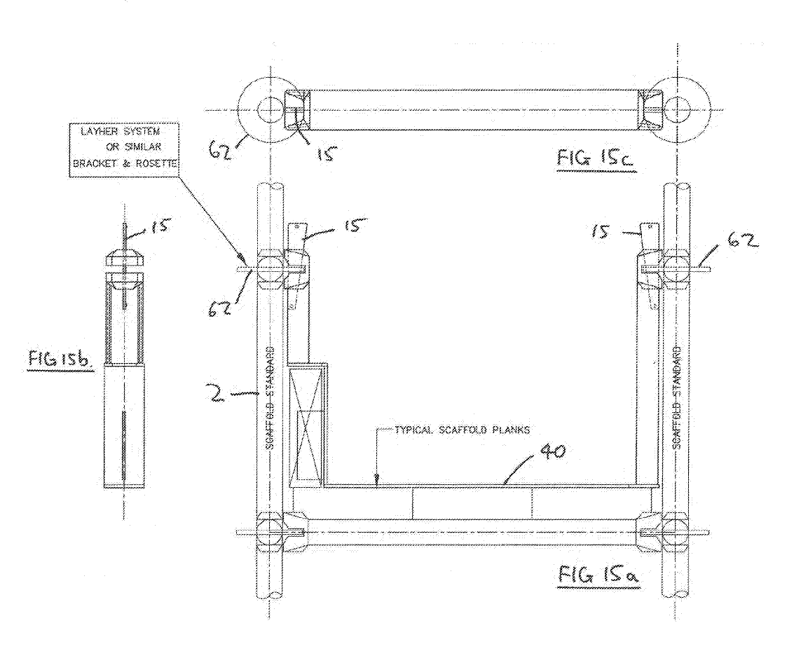

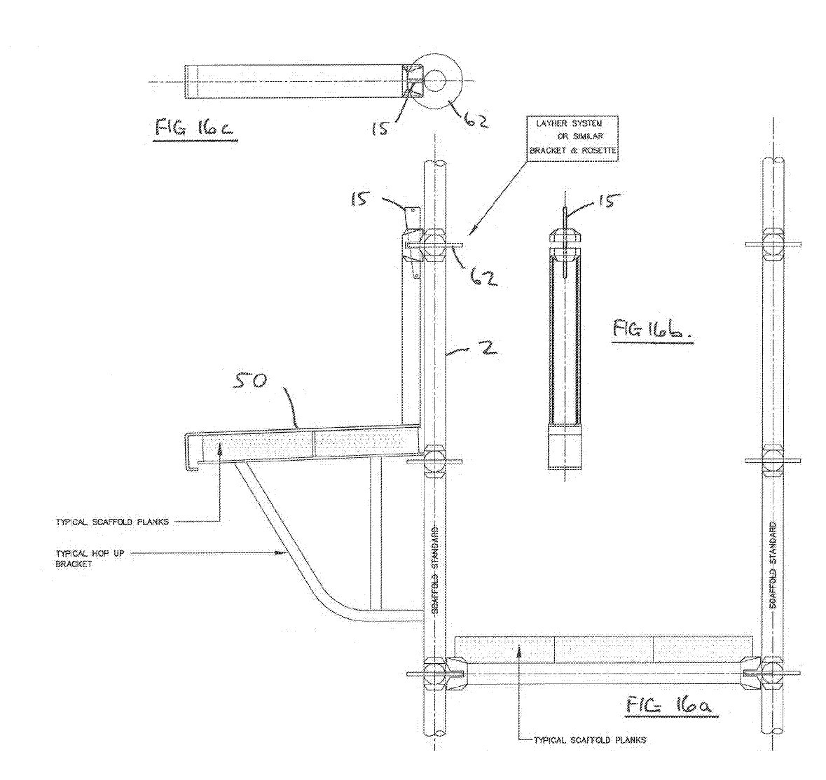

Specific examples of different connection systems are illustrated in FIGS. 11 to 16, where like components are denoted with like reference numerals.

FIGS. 11a to 11c show front, side and top views respectively of a device 1 connected to the scaffold 2 via a CUPLOCK™ or equivalent system, where each coupling 7, 11 is in the form of a blade or spigot 59 attached to the top end of each riser 5, 9. The spigots 59 are secured in top and bottom cup locks 60, 61 which are mounted to the associated standards 3, 4.

As with the device 1 of FIGS. 1 to 5, each riser 5, 9 is formed of upright parts 21 that define a void 39 which is adapted to receive a wedge lock or the like (not shown) used to connect the platform 28 to the scaffold 2, to avoid the wedge lock being a trip hazard and/or unintentionally disengaging.

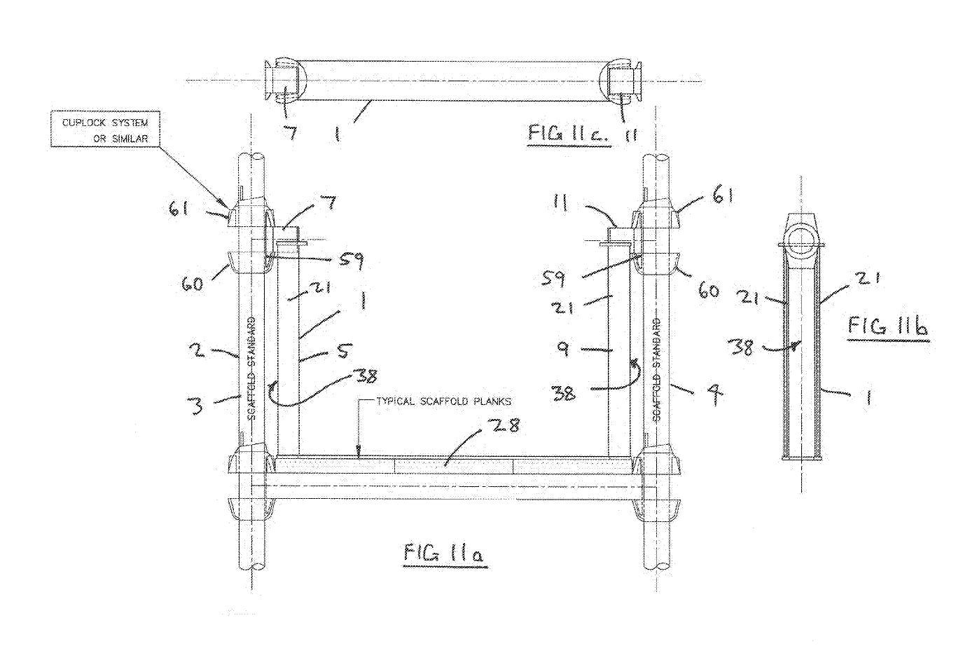

FIGS. 12a to 12c show similar views to FIG. 11, where cup locks 60, 61 and associated spigots 59 are used to attach a device 40 to the scaffold.

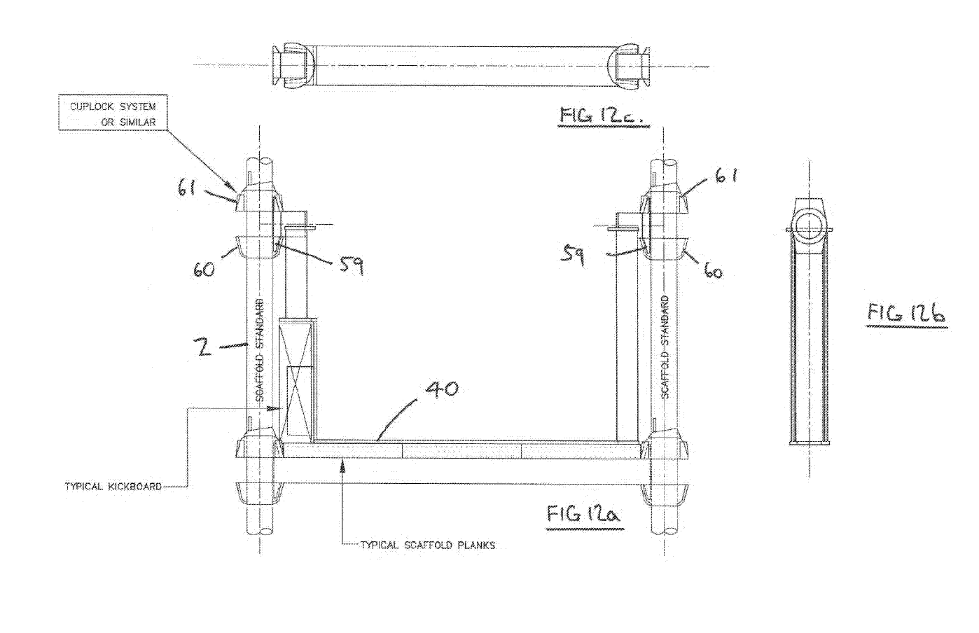

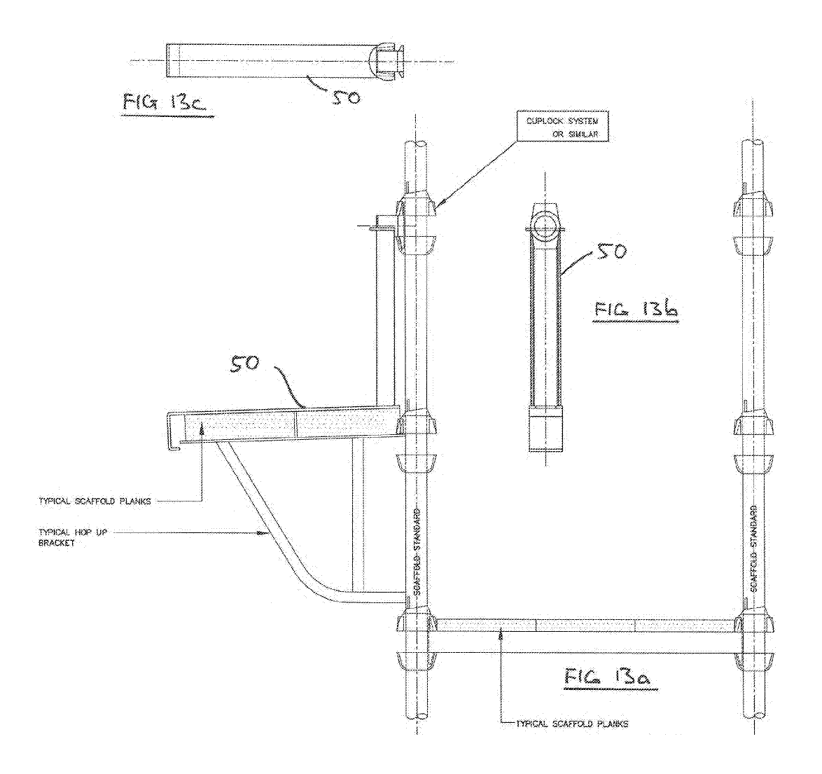

FIG. 13 illustrates the same connection system used to couple the device 50 to the scaffold 2.

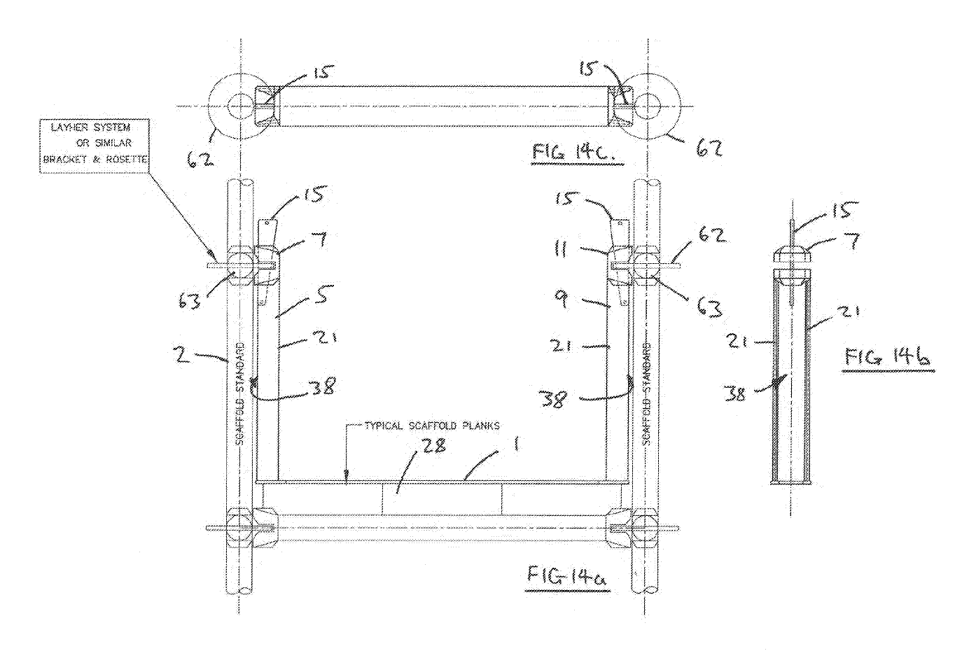

FIGS. 14a to 14c show front, side and top views respectively of the device 1 connected to scaffold 1 via a LAYHER™ or equivalent system, where each coupling 7, 11 includes a spigot or wedge 15 attached through a ring or rosette 62 mounted to the respective standard 3, 4 via an associated bracket 63.

The upright parts 21 of the risers 5, 9 define a void 38 which accommodates a wedge lock or the like (not shown) used to secure the platform 28 in place in order to avoid trip hazard. The upright parts 21 and the void 38 also accommodate the wedge 15 of the coupling 7, 11 at a top end and provide lateral protection from damage and knocks and inadvertent release of the wedge 15.

Many modifications and variations may be made without departing from the spirit and scope of the invention described.

### LIST OF PARTS

1. Device
2. Scaffold
3. Inner standard
4. Outer standard
5. Riser
6. Keeper
7. Coupling
8. Fitting
9. Second riser
10. End
11. Second coupling
12. Fitting
13. Wedge lock
14. Finger
15. Wedge
16. Underside
17. Bar
18. Notch
19. End
20. Feet
21. Part
22. Base
23. Cross piece
24. Guide
25. Slot
26. Top surface
27. Board
28. Platform
29. Deck
30. Transom
31. End
32. End
33. Fitting
34. Bracket
35. Wedge lock
36. Scaffold
37. End
38. Void
39. Device
40. Step section
41. L-shaped connection
42. Kickboard
43. Tail
44. Hole
45. Hole
46. Stop
47. Tab
48. Wedge
49. Device
50. Hop-up
51. Frame
52. Wedge lock
53. Bracket
54. Fitting
55. Lip
56. Edge
57. Return
58. Spigot
59. Cup lock
60. Cup lock
61. Ring
62. Bracket

1. A device for locking down a board of a platform supported on transoms connected between standards of a scaffold, including a riser adapted to be positioned lengthwise of one of the standards, a keeper positioned transversely of the riser to hold the board in place and a coupling to engage a fitting on the standard to lock the device in position, wherein the riser includes a base with an aperture that provides access to a void between upright parts of the riser to accommodate a wedge lock used to connect the platform to the scaffold.

2. The device of claim 1, wherein the upright parts extend up to the coupling and laterally shield the coupling from damage.

3. The device of claim 1, wherein the keeper is adapted to hold multiple boards and is in the form of an elongate bar that extends across a top surface of the boards in order to hold the boards in a horizontal orientation.

4. The device of claim 1, wherein the coupling is adapted to engage an inner standard and the device further includes a second riser and coupling connected to an opposite end of the keeper, to engage with an associated fitting of an outer standard.

5. The device of claim 4, further including a step section adjacent one of the risers to accommodate a kick board mounted along a lateral edge of the platform.

6. The device of claim 5, further including a stop for an end of the kickboard to abut when the kickboard is received in the step section.

7. The device of claim 6, wherein the stop is in the form of a vertical tab positioned intermediate side edges of the step section.

8. The device of claim 5, wherein the step section provides an L-shaped connection between the adjacent riser and the keeper.

9. The device of claim 1, adapted to secure boards of a hop-up platform, further including a downturned lip remote from the riser to secure an outside edge of the platform.

10. The device of claim 9, wherein the keeper is in the form or an elongate bar that extends across a top surface of the boards, and wherein the lip projects downwardly from an end of the keeper.

11. The device of claim 1, wherein the or each coupling includes a spigot for quick connect engagement with a fitting of the associated standard.

12. The device of claim 1, wherein the or each coupling is in the form or a wedge lock for connection with a V-press fitting of the associated standard.

13. The device of claim 1, wherein the or each coupling includes a spigot or blade for connection with a cup lock system of the associated standard.

14. The device of claim 1, wherein the or each coupling includes a spigot or wedge for connection with a ring or rosette mounted to the associated standard.

15. Scaffold including standards and the device of claim 1, wherein the standards are provided with one or more fittings adapted to engage with the or each coupling of the device.
